(19) United States
(12) Patent Application Publication
(10) Pub. No.: US 2026/0296389 A1
(43) Pub. Date: Oct. 1, 2026

(54) METHOD AND DEVICE FOR OPERATING AN ANTI-LOCK BRAKING SYSTEM OF A VEHICLE

(71) Applicant: ZF CV Systems Global GmbH, Bern (CH)

(72) Inventors: Robin Szymanski, Hannover, DE (US); Andreas Marx, Seelze (DE)

(21) Appl. No.: 19/480,582

(22) PCT Filed: Apr. 23, 2024
(86) PCT No.: PCT/EP2024/061015

§ 371 Date: Oct. 31, 2025

(30) Foreign Application Priority Data
May 3, 2023 (DE) 10 2023 111 425.5
Dec. 21, 2023 (DE) 10 2023 136 213.5

(51) Int. Cl. B60T 8/1763; B60T 8/171; B60T 8/1761

(52) U.S. Cl. CPC B60T 8/1763; B60T 8/171; B60T 8/1761; B60T 2210/12; B60T 2240/00

(57) ABSTRACT

A method (100) for operating an anti-lock braking system (220) of a service brake (210) in relation to an axle (205) in order to brake a wheel (215) of the axle (205) of a vehicle (200a), in particular a utility vehicle (200b) takes into account information external to the axle being braked. The method (100) includes: recording (110) an input variable (260) external to the axle; ascertaining (120) a control variable (270) relating to an axle and/or relating to the wheel (215) of the axle (205) on the basis of the input variable (260) external to the axle; and outputting (130) a control signal (280) for changing a braking variable (211) of the service brake (210), taking into account the control variable (270) relating to the axle and/or relating to the wheel (215) of the axle (205).

### FIELD

The present disclosure relates to a method for operating an anti-lock braking system of a service brake in relation to an axle in order to brake a wheel of the axle of a vehicle, in particular a utility vehicle, to a computer program and/or a computer-readable medium, to a control unit for a vehicle, in particular a utility vehicle, and to a vehicle, in particular a utility vehicle.

### BACKGROUND

Braking systems for vehicles having an anti-lock braking system (ABS) are known from the prior art. The braking system is designed to exert a braking torque on a wheel or multiple wheels of the vehicle in order to decelerate the vehicle. The ABS reduces or prevents the locking of a wheel braked by the braking system by reducing a brake pressure and may therefore improve a braking procedure as well as the driving safety.

ABS are known, which record the wheel speed of the wheel to be braked and, in the event of too abrupt a change in speed, cause a reduction in the brake pressure in order to avoid or end any locking of the wheel.

Furthermore, centrally controlled braking systems are known, which enable a braking force distribution and/or vehicle dynamics control, for example using input signals from a yaw sensor.

DE 10 2018 123 996 A1 discloses an at least two-channel electro-pneumatic central pressure control module, designed as a structural unit, for an electro-pneumatic service brake device of a vehicle, having at least two pressure control channels, which can be electrically controlled with regard to a brake pressure. It is provided here that a central electronic brake control unit has a circuit board which supports electric and electronic components, wherein routines at least for the brake pressure control and for the vehicle dynamics control are implemented in the electric and electronic components, wherein at least one inertial sensor is arranged on or in the at least one circuit board and is connected in an electrically conductive manner to at least some of the electronic and electronic components on the circuit board such that the output signals of the at least one inertial sensor can be fed into the at least some electric and electronic components for the purpose of carrying out the vehicle dynamics control. Optionally, ABS pressure control valves may also be connected between the central pressure control module as a “central module” and brake cylinders at wheels of a first axle and a second axle, which ABS pressure control valves enable the brake pressure in these brake cylinders to be controlled in a wheel-specific manner. The central electronic brake control unit of the electro-pneumatic service brake device, which, in addition to brake pressure control, may also relate to even higher functions, for example the braking force distribution to the front and rear axle, vehicle dynamics control and/or an anti-lock braking system (ABS), is integrated in the central pressure control module.

The ABS pressure control valves here are controlled by the central electronic brake control unit. An anti-lock braking system of a wheel of an axle according to the prior art controls the braking of the wheel on the basis of information which relates to the wheel and/or the axle itself, possibly influenced by an input signal of the central control unit.

Such control of an ABS, however, may result in an axle load transfer and a movement of a driver's cab of the vehicle, in particular with certain friction properties of the roadway or ground and particular vehicle configurations.

Furthermore, it can be observed that, for example, ABS pressure control valves are subject to increasingly high demands in terms of cost-effectiveness. In this regard, an improvement to the control of an ABS may compensate the repercussions of such demands and/or nevertheless improve the effect of the ABS.

### SUMMARY

The present disclosure is therefore based on the object of enhancing the prior art. One embodiment achieves the object of providing an improved performance of an ABS braking system and/or improving the vehicle stability and/or reducing an axle load transfer and/or reducing movement of a driver's cab and therefore improving the safety and comfort.

Said object is achieved by way of a method according to the subject matter of the present disclosure.

According to one aspect of the present disclosure, a method for operating an anti-lock braking system of a service brake in relation to an axle in order to brake a wheel of the axle of a vehicle, in particular a utility vehicle, is provided. The method comprises: recording an input variable external to the axle; ascertaining a control variable relating to an axle and/or relating to the wheel of the axle on the basis of the input variable external to the axle; and outputting a control signal for changing a braking variable of the service brake, taking into account the control variable relating to the axle and/or relating to the wheel of the axle.

The vehicle, in particular the utility vehicle, is referred to below as vehicle. The method is therefore a method for controlling the anti-lock braking system (ABS) of the vehicle. To this end, the input variable external to the axle is recorded. The input variable external to the axle here may be a variable relating to the vehicle, but not or not solely to the axle having the wheel to be braked, and/or a variable relating to a further axle of the vehicle. The input variable external to the axle may be recorded via a sensor and/or via communication technology, for example via a vehicle bus and/or via an interface for communication outside the vehicle. The input variable may comprise a plurality of different pieces of information. Comprehensive characterization for variables which are potentially relevant for braking is thus possible.

The control variable may be ascertained on the basis of the input variable. The control variable here is a variable which relates to the axle having the wheel to be braked and/or to the wheel of the axle that is to be braked. The control variable here may relate to the control for the braking of the wheel and/or the wheels of the axle. In other words, the control variable may be, in particular, a control variable relating to a wheel, in particular in the case of wheel-specific control of the braking.

Taking into account the control variable, the control signal for changing the braking variable of the service brake may be output. The braking variable here may be adjusted, for example, on the basis of the control variable. A predictable change to the control variable may be brought about by the control signal. The braking variable here may be a variable determining the braking torque of the wheel and/or the wheels of the axle which may be applied to the service brake as a result of the control signal.

The present disclosure provides an approach which enables the wheel and/or the axle to be controlled by the ABS depending on information, data or variables which are not dependent, or are only indirectly dependent, on the control of the wheel and/or the axle. It has been recognized here that such a variable may typically describe the vehicle dynamics, an environment and/or other circumstances and/or features, which may have an influence on the control of the ABS. Such an approach here may also be applied in relation to automated driving functions and/or applications for autonomous driving, since meaningful input variables are typically already recorded and/or processed by the vehicle here.

The method may be applied in a wheel-specific manner here, i.e. to only one wheel of the axle. Alternatively or in addition, the method may be applied to multiple wheels of the axle and/or for multiple wheels of an axle package comprising multiple axles.

Optionally, the control signal comprises a trigger signal for activating an ABS control by the anti-lock braking system. It is therefore possible to activate an ABS which has not previously been activated. Alternatively or in addition, the control signal comprises a selection signal for selecting a control strategy for the anti-lock braking system. It is therefore possible to selectively switch the control by the ABS from a control which is already taking place according to one control strategy to a control according to a different strategy. Alternatively or in addition, the control signal comprises an input signal for determining the change to the control variable. It is therefore possible to change the intensity of the brake control by the ABS, for example as a braking variable of a braking force, a braking torque and/or a brake pressure.

Optionally, the control signal is output such that a change to the braking variable takes place alternatively or in addition to an ABS control by the anti-lock braking system and/or alternately therewith. It is therefore possible that the setting of the braking variable by the ABS may be replaced or changed as a result of the control signal. The replacement and/or change may take place alternately, i.e. in an alternating manner, for example periodically. In other words, an intervention in the ABS may take place independently of the ABS or in combination with the ABS as a result of a change to or influence on the ABS control.

Optionally, the control signal is output such that the change to the braking variable and an ABS control by the anti-lock braking system are superimposed. This may enable a transition between the change to the braking variable and the ABS control. For example, depending on a pressure decrease, priority may be given to the change to the braking variable via the control signal or to the ABS control in order to reliably prevent locking of the wheel. The superimposition may achieve a balance between the shortest possible braking distance and the stability of the vehicle dynamics. Optionally, the ABS control takes precedence in order to meet legal and/or standardized specifications.

Optionally, the input variable external to the axle comprise a vehicle dynamics variable and/or sensor data of a vehicle dynamics control. The vehicle dynamics variable and/or sensor data here relate to information, data or variables of a further wheel of a further axle, wherein the further axle is different from the axle having the wheel to be braked. The input variable external to the axle here may comprise, in particular, a yaw rate, a pitch rate, a wheel speed of a wheel external to the axle, an axle load of a wheel external to the axle, a normal force acting between a further wheel of a further axle and the ground and/or a friction coefficient between the further wheel of the further axle and the ground. The yaw rate of the vehicle, the pitch rate of the vehicle, the wheel speed, the axle load and the normal force can be measured via sensors here and are variables which influence and/or reflect the vehicle dynamics, i.e. they are vehicle dynamics variables. A slip of a wheel may be calculated on the basis of the wheel speeds. The friction coefficient as a vehicle dynamics variable provides information relating to an achievable slip.

Optionally, the input variable external to the axle comprises operating data of the vehicle, in particular the utility vehicle. The operating data of the vehicle may comprise data which can be retrieved via a vehicle bus, for example. The operating data may have, as their basis, an actuation on the part of the driver and/or via an automated driving function. Alternatively or in addition, the input variable external to the axle comprises an environment variable relating to an environment of the vehicle, in particular the utility vehicle. In particular, the environment variable may characterize properties of the ground or roadway. The environment variable can be detected by sensors and/or it can be retrieved outside the vehicle. The environment variable may comprise, for example, a road gradient and/or a friction value of the roadway. Alternatively or in addition, the input variable external to the axle relates to a driving situation. With this, braking may be made dependent on whether a hazardous situation is present. The previously mentioned data or variables may be evaluated in combination with one another. For example, a wiper signal as operating data in combination with a low temperature as an environment variable may indicate a slippery roadway, i.e. a roadway with a low friction value.

Optionally, the control variable relating to the axle and/or relating to the wheel of the axle comprises a predicted wheel speed, a predicted slip threshold, a predicted friction coefficient and/or a predicted normal force between the wheel and the ground. The control variable may therefore comprise information relating to the wheel and/or the axle, which may be vital for safety and/or driving comfort.

According to one aspect of the disclosure, a computer program and/or a computer-readable medium is provided. The computer program and/or the computer-readable medium comprises/comprise commands which, when the program or the commands is or are executed by a computer, cause the latter to carry out the method according to the present disclosure and/or steps of said method. Optionally, the computer program and/or the computer-readable medium comprises/comprise commands which, when the program or the commands is or are executed by a computer, cause the latter to carry out the method steps described as being advantageous or optional, in order to achieve a technical effect associated therewith.

According to one aspect of the present disclosure, a control unit for a vehicle, in particular a utility vehicle, is provided. The control unit here is designed to carry out the method described above. Optionally, the control unit is designed to carry out the method such that one or more of the features described as optional above are realized in order to achieve an associated technical effect.

According to one aspect of the present disclosure, a vehicle, in particular a utility vehicle, comprising a service brake with an anti-lock braking system and the control unit described above, is provided. The control unit here may have one or more features described as optional in order to achieve an associated technical effect.

### BRIEF DESCRIPTION OF THE DRAWINGS

Further advantages and features of the present disclosure as well as the technical effects thereof are revealed in the figures and the description of the preferred embodiments shown in the figures. In the figures

FIG. 1 shows a schematic illustration of a vehicle, in particular a utility vehicle, according to one embodiment of the present disclosure;

FIG. 2 shows a schematic illustration of a flow chart of a method according to one embodiment of the present disclosure; and

FIG. 3 shows a schematic illustration of a time development of different variables relating to a vehicle, in particular a utility vehicle, during operation of an anti-lock braking system according to the prior art compared with corresponding variables during operation of an anti-lock braking system according to a method according to one embodiment of the present disclosure.

### DETAILED DESCRIPTION

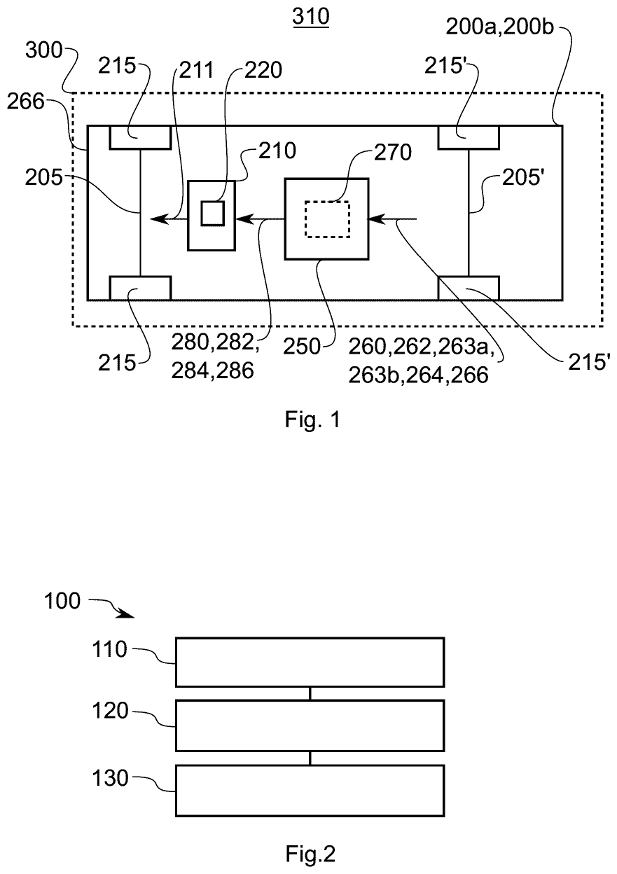

FIG. 1 shows a schematic illustration of a vehicle 200a, in particular a utility vehicle 200b, of one embodiment of the present disclosure.

The vehicle 200a, in particular the utility vehicle 200b, is referred to below as vehicle 200a, 200b. The vehicle 200a, 200b is a land vehicle, for example a traction engine of a multi-unit utility vehicle.

The vehicle 200a, 200b is positioned on the ground 300 in an environment 310 and is in a driving situation 266. The ground 300 is, for example, a roadway with possibly locally varying features. The features of the ground 300 have an influence on a friction value and therefore the driving dynamics of the vehicle 200a, 200b and, in particular, the braking of the vehicle 200a, 200b.

The vehicle 200a, 200b includes multiple axles 205, 205′, for example two axles 205, 205′. The vehicle 200a, 200b includes a plurality of wheels 215, 215′ associated with the axles 205, 205′, for example two wheels 215, 215′ for each axle 205, 205′. In an embodiment which is not shown, the vehicle 200a, 200b has more than two axles 205, 205′ and/or the vehicle 200a, 200b has more than two, for example four, wheels 215, 215′ on at least one of the axles 205, 205′.

The vehicle 200a, 200b is positioned with the wheels 215, 215′ on the ground 300. That is to say the wheels 215, 215′ are in contact with the ground 300. The wheels 215, 215′ and the ground 300 are in operative contact with one another along a contact surface. A friction value, which characterizes the contact between the respective wheel 215, 215′ and the ground 300, can be defined at the contact surface between the wheels 215, 215′ and the ground 300. The friction value may be different for each of the wheels 215, 215′.

The vehicle 200a, 200b includes a service brake 210. The service brake 210 is a pneumatic, hydraulic and/or electro-mechanical brake. The service brake 210 is designed to achieve a braking effect for braking the vehicle 200a, 200b. To this end, the service brake 210 is designed to slow a movement of the wheels 215, 215′, or to control the slowing of the movement of the wheels 215, 215′. The service brake 220 may apply a braking variable 211, for example a braking torque, a braking force and/or a brake pressure, in order to decelerate the wheel(s) 215, 215′. Slip is established at the wheels 215, 215′ a result of the vehicle 200a, 200b being driven and/or braked.

The service brake 210 includes an anti-lock braking system 220. The anti-lock braking system 220 is designed to detect a locking tendency of the wheels 215, 215′ and to prevent locking of the wheels 215, 215′ and/or to reduce the locking tendency of the wheels 215, 215′. To this end, the anti-lock braking system 220 is designed to intervene in the braking and to reduce the braking variable 211 if, for example, a locking tendency is detected.

The vehicle 200a, 200b includes a control unit 250. The control unit 250 is designed to carry out the method 100 described with reference to FIG. 2.

The control unit 250 according to FIG. 1 is designed to record an input variable 260 external to the axle. The input variable 260 external to the axle relates, for example, to the vehicle 200a, 200b, the driving and/or braking of the vehicle 200a, 200b, the further axle 205′ and/or the further wheels 215′ of the further axle 205′. The input variable 260 external to the axle includes a vehicle dynamics variable 262 and/or sensor data of a vehicle dynamics control. To this end, the control unit 250 is connected to corresponding sensors, a vehicle bus and/or a communication device for communication outside the vehicle (not shown). As an input variable 260, the control unit 250 may therefore comprise, in particular, a yaw rate 263a of the vehicle 200a, 200b, a pitch rate 263b of the vehicle 200a, 200b, a wheel speed of the wheel 215′ external to the axle, an axle load of the wheel 215′ external to the axle, a normal force acting between the further wheel 215′ of the further axle 205′ and the ground 300 and/or a friction coefficient between the further wheel 215′ of the further ale 205′ and the ground 300. In particular, as an input variable 260 external to the axle, the control unit 250 may retrieve operating data of the vehicle 200a, 200b, an environment variable 264 relating to the environment 310 of the vehicle 200a, 200b and/or information relating to the driving situation 266 via the vehicle bus.

The control unit 250 is designed to ascertain a control variable 270 relating to the axle and/or relating to the wheel 215 of the axle 205 on the basis of the input variable 260 external to the axle. The control variable 270 relating to the axle includes a predicted wheel speed, a predicted slip limit, a predicted friction coefficient and/or a predicted normal force between the wheel 215 and the ground 300.

The control unit 250 is designed to output a control signal 280 to the service brake 210 in order to change the braking variable 211 of the service brake 210, taking into account the control variable 270 relating to the axle. The control signal 280 includes a trigger signal 282 for activating an ABS control by the anti-lock braking system 220, a selection signal 284 for selecting a control strategy for the anti-lock braking system 220 and an input signal 286 for determining the change to the braking variable 211. The control signal 280 is output such that the change to the braking variable 211 takes place alternatively or in addition to an ABS control by the anti-lock braking system 220 and/or alternately therewith. The control signal 280 is output such that the change to the braking variable 211 and an ABS control by the anti-lock braking system 220 are superimposed.

The vehicle 200a, 200b is therefore designed to control an anti-lock braking system 220 of a steerable front axle, here the axle 205, on the basis of sensor data of a vehicle dynamics control (electronic stability program-ESC). In the case of an mu-split scenario, i.e. with different friction values of the wheels 215 of the axle 205, the yaw rate 263a may be used to set the braking variable 211, whilst, according to the prior art, typically only data relating to the axle 205, such as a pressure and/or wheel speed of the wheel 215, were used here.

The vehicle 200a, 200b is furthermore designed to reduce and/or to avoid possible negative effects of an axle load transfer. A significant axle load transfer may cause an abrupt loss of traction of a wheel 215, 215′, i.e. an undesirably high increase in the slip, for example due to a reduction in the normal force acting on the wheel 215, 215′. If the axle load transfer is too great, a braking system according to the prior art might not provide the required pressure decrease quickly enough and might therefore further reinforce the axle load transfer. The vehicle 200a, 200b according to FIG. 1 is designed to maintain or reduce the braking variable 211 for the front axle 205 if the further wheel 215′ of the further axle 205′, i.e. the rear axle, decelerates. Therefore, in the event of a subsequent axle load transfer to the rear, a loss of traction of the wheel 215 of the front axle 205 may be counteracted. Alternatively or in addition, the control unit 250 is designed to calculate a model for the axle load transfer, to predict the axle load transfer and to change the braking variable 211 according to a prediction of the axle load transfer.

The vehicle 200a, 200b is designed to carry out automated driving functions. The vehicle 200a, 200b may therefore gather information about the ground 300 along a trajectory to be driven from other vehicles which have already driven along the trajectory. A change to the roadway properties and, in particular, the friction values along the trajectory may be predicted on the basis of the data which are external to the vehicle and relate to the ground 300, and the braking variable 211 may be set on the basis of a prediction of the friction values along the trajectory.

FIG. 2 shows a schematic illustration of flow chart of a method 100 according to one embodiment of the present disclosure. The method 100 is a method 100 for operating an anti-lock braking system 220 of a service brake 210 in relation to an axle 205 in order to brake a wheel 215 of the axle 205 of a vehicle 200a, in particular a utility vehicle 200b. Such a vehicle 200a, 200b is described with reference to FIG. 1. FIG. 2 is described with reference to FIG. 1.

According to FIG. 2, the method 100 includes: recording 110 an input variable 260 external to the axle. The input variable 260 external to the axle includes a vehicle dynamics variable 262 and/or sensor data of a vehicle dynamics control, in particular a yaw rate 263a, a pitch rate 263b, a wheel speed of a wheel 215′ external to the axle, an axle load of a wheel 215′ external to the axle, a normal force acting between a wheel 215′ of a further axle 205′ and the ground 300 and/or a friction coefficient between the wheel 215′ of the further axle 205′ and the ground 300. The input variable 260 external to the axle includes operating data of the vehicle 200a, in particular the utility vehicle 200b, an environment variable 264 relating to an environment 310 of the vehicle 200a, in particular the utility vehicle 200b, and/or a driving situation 266.

The ascertainment 120 of a control variable 270 relating to the axle and/or relating to the wheel 215 of the axle 205 takes place on the basis of the input variable 260 external to the axle. The control variable 270 relating to the axle and/or relating to the wheel 215 of the axle 205 includes a predicted wheel speed, a predicted slip threshold, a predicted friction coefficient and/or a predicted normal force between the wheel 215 and the ground 300.

A control signal 280 for changing a braking variable 211 of the service brake 210 is then output 130, taking into account the control variable 270 relating to the axle and/or relating to the wheel 215 of the axle 205. The control signal 280 includes a trigger signal 282 for activating an ABS control by the anti-lock braking system 220, a selection signal 284 for selecting a control strategy for the anti-lock braking system 220 and/or an input signal 286 for determining the change to the braking variable 211. The control signal 280 is output such that the change to the braking variable 211 takes place alternatively or in addition to an ABS control by the anti-lock braking system 220 and/or alternately therewith. The control signal 280 is output such that the change to the braking variable 211 and an ABS control by the anti-lock braking system 220 are superimposed.

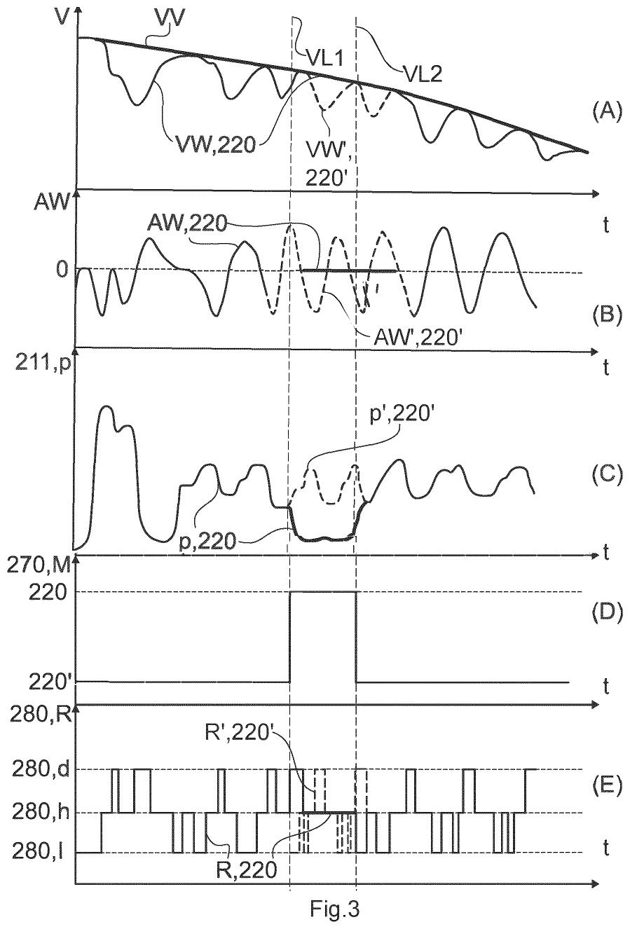

FIG. 3 shows a schematic illustration of a time development of different variables relating to a vehicle 200a, in particular a utility vehicle 200b, during operation of an anti-lock braking system 220′ according to the prior art compared with corresponding variables during operation of an anti-lock braking system 220 according to a method 100 according to one embodiment of the present disclosure. Such a vehicle 200a or utility vehicle 200b is described with reference to FIG. 1 and such a method 100 is described with reference to FIG. 2. FIG. 3 is described with reference to FIGS. 1 and 2.

FIG. 3 is divided into five sections (A), (B), (C), (D) and (E). Each of the sections (A), (B), (C), (D) and (E) shows a variable depending on time t. The time axis here is scaled such that FIG. 3 shows a braking procedure of the vehicle 200a, 200b.

The variables during the operation of an anti-lock braking system 220 according to a method 100 according to one embodiment of the present disclosure are each illustrated by a continuous line. The variables during the operation of an anti-lock braking system 220′ according to the prior art differ in some sections, in particular shown by dashed lines, from variables during the operation of an anti-lock braking system 220 according to a method 100 according to one embodiment of the present disclosure. The variables during the operation of an anti-lock braking system 220′ according to the prior art are each illustrated by a dashed line.

Section (A) shows speed V as a function of time. The upper continuous line here shows a vehicle speed VV, i.e. the speed V of the vehicle 200a or utility vehicle 200b. Deviating somewhat from the vehicle speed VV, the wheel speed VW, VW′ of the wheel 215 of the vehicle 200a or utility vehicle 200b is shown, i.e. the wheel speed of the wheel 215 on the axle 205 of which the anti-lock braking system 220, 220′ acts. The wheel speed VW here relates to an anti-lock braking system 220 according to a method 100 according to one embodiment of the present disclosure. The wheel speed VW′ relates to an anti-lock braking system 220′ according to the prior art.

Section (B) shows a wheel acceleration AW, AW′ corresponding to the wheel speed VW of the wheel 215, i.e. a time derivation of the wheel speed VW, VW. The wheel acceleration AW here relates to an anti-lock braking system 220 according to a method 100 according to one embodiment of the present disclosure. The wheel acceleration AW′ relates to an anti-lock braking system 220′ according to the prior art.

Section (C) shows a brake pressure p, p′ as a function of time as an example of a braking variable 211 which is changed as a result of an intervention by the anti-lock braking system 220, 220′. The brake pressure p here relates to an anti-lock braking system 220 according to a method 100 according to one embodiment of the present disclosure. The brake pressure p′ relates to an anti-lock braking system 220′ according to the prior art.

Section (D) shows a mode M of the anti-lock braking system 220 according to the present disclosure or an anti-lock braking system 220′ according to the prior art as a function of time t as an exemplary control variable 270. The mode M indicates here whether the anti-lock braking system 220′ according to the prior art is used or the anti-lock braking system 220 according to the method 100 according to the present disclosure. A binary variable is therefore shown in section (D). However, by superimposing the change to the braking variable 211 according to the method 100 according to the present disclosure and an ABS control by the anti-lock braking system 220′ according to the prior art, the mode M may also assume other values (not shown). Furthermore, another control variable 270 may be defined in addition or alternatively to the mode M (see description of FIGS. 1 and 2).

Section (E) shows a pressure request R, R′ as a function of time t as an exemplary control signal 280. The pressure request R, R′ may assume three values and may control a reduction d in the braking variable 211, the maintaining h of the braking variable 211 or an increase i in the braking variable 211. However, the pressure request R, R′ may also assume other values (not shown). Furthermore, another control variable 280 may be defined in addition or alternatively to the pressure request R (see description of FIGS. 1 and 2). The pressure request R here relates to an anti-lock braking system 220 according to a method 100 according to one embodiment of the present disclosure. The pressure request R′ relates to an anti-lock braking system 220′ according to the prior art.

As can be seen from the mode M and from the control signal 280, highlighted by the dashed lines VL1, VL2 extending vertically through sections (A), (B), (C), (D) and (E), the control signal 280 is output such that the change to the braking variable 211 takes place alternatively and in addition to an ABS control by the anti-lock braking system 220. The ABS control by the anti-lock braking system 220 takes place outside the time period highlighted by the vertical lines, i.e. before the first vertical line VL1 and after the second vertical line VL2. The change to the braking variable 211 and the ABS control by the anti-lock braking system 220 also take place alternately here: firstly, the ABS control by the anti-lock braking system 220 takes effect-the mode M therefore corresponds to the anti-lock braking system 220′ according to the prior art; the change to the braking variable 211, which is defined by the control signal 280 and can be seen by reference to the mode M for the anti-lock braking system 220, the takes effect according to the method 100 according to the present disclosure; and, finally, the ABS control by the anti-lock braking system 220 takes effect as at the outset.

In the time period highlighted by the vertically extending dashed lines VL1, VL2, the ABS control by the anti anti-lock braking system 220 is replaced by the change to the braking variable 211 according to the method 100 according to the present disclosure; the change to the braking variable 211 therefore takes place alternatively to an ABS control by the anti-lock braking system 220. In terms of the entire braking procedure, the change to the braking variable 211 takes place in addition to an ABS control by the anti-lock braking system 220, since the ABS control by the anti-lock braking system 220 takes effect before and after the change to the braking variable 211.

Sections (A) and (B) illustrate the effect of the method 100 on the wheel 215: whilst the wheel 215 in the case of the anti-lock braking system 220′ according to the prior art shows a continuous and repeated slip, i.e. a repeated reduction in the wheel speed VW′ in relation to the vehicle speed WV, the wheel speed VW approaches the vehicle speed VV in the event that the braking variable 211 is changed according to the method 100. This is also shown in the wheel acceleration AW, AW, which oscillates further according to the prior art but remains constant according to the present disclosure.

This is as a result of the brake pressure p, p′ according to section (C). Whilst, according to the prior art, an oscillating or alternating increase i and reduction d in the brake pressure p′ takes place, the brake pressure p according to the present disclosure is reduced and is then maintained in the example shown. This can be seen from the control signals 280 in section (E), on the basis of which, according to the present disclosure, the brake pressure is firstly reduced d and then maintained h in the example shown. In the prior art, the brake pressure p′ would be alternately reduced and increased.

### Reference Signs (Part of the Description)

100 Method
110 Record
120 Ascertain
130 Output
200a Vehicle
200b Utility vehicle
205, 205′ Axle
210 Service brake
211 Braking variable
215, 215′ Wheel
220 Anti-lock braking system (according to the present disclosure)
220′ Anti-lock braking system (according to the prior art).
250 Control unit
260 Input variable external to the axle
262 Vehicle dynamics variable
263a Yaw rate
263b Pitch rate
264 Environment variable
266 Driving situation
270 Control variable
280 Control signal
282 Trigger signal
284 Selection signal
286 Input signal
300 Ground
310 Environment
AW Wheel acceleration (according to the present disclosure)
AW Wheel acceleration (according to the prior art).
d Reduce
h Maintain
i Increase
M Mode
p Brake pressure (according to the present disclosure)
p′ Brake pressure (according to the prior art).
R Pressure request (according to the present disclosure)
p′ Pressure request (according to the prior art)
t Time
V Speed
VL1 First vertical line
VL2 Second vertical line
W Vehicle speed
VW Wheel speed (according to the present disclosure)
VW′ Wheel speed (according to the prior art).

1. A method (100) for operating an anti-lock braking system (220) of a service brake (210) in relation to an axle (205) in order to brake a wheel (215) of the axle (205) of a vehicle (200a), wherein the method (100) comprises:
recording (110) an input variable (260) external to the axle;
ascertaining (120) a control variable (270) relating to the axle and/or relating to the wheel (215) of the axle (205) on the basis of the input variable (260) external to the axle; and
outputting (130) a control signal (280) for changing a braking variable (211) of the service brake (210), taking into account the control variable (270) relating to the axle and/or relating to the wheel (215) of the axle (205).

2. The method (100) as claimed in claim 1, wherein the control signal (280) comprises a trigger signal (282) for activating an ABS control by the anti-lock braking system (220), a selection signal (284) for selecting a control strategy for the anti-lock braking system (220), and/or an input signal (286) for determining the change to the braking variable (211).

3. The method (100) as claimed in claim 2, wherein the control signal (280) is output such that the change to the braking variable (211) takes place alternatively or in addition to an ABS control by the anti-lock braking system (220) or alternately therewith.

4. The method (100) as claimed in claim 1, wherein the control signal (280) is output such that the change to the braking variable (211) and an ABS control by the anti-lock braking system (220) are superimposed.

5. The method (100) as claimed in claim 1, wherein the input variable (260) external to the axle comprises a vehicle dynamics variable (262) and/or sensor data of a vehicle dynamics control.

6. The method (100) as claimed in claim 1, wherein the input variable (260) external to the axle comprises operating data of the vehicle (200a), an environment variable (264) relating to an environment (310) of the vehicle (200a), and/or a driving situation (266).

7. The method (100) as claimed in claim 6, wherein the control variable (270) relating to the axle and/or relating to the wheel (215) of the axle (205) comprises a predicted wheel speed, a predicted slip threshold, a predicted friction coefficient, and/or a predicted normal force between the wheel (215) and the ground (300).

8. A non-transitory computer-readable medium, comprising commands which, when commands are executed by a computer, cause the computer to carry out the method (100) as claimed in claim 1.

9. A control unit (250) for a vehicle (200a), wherein the control unit (250) is designed to carry out the method (100) as claimed in claim 1.

10. A vehicle (200a) comprising a service brake (210) having an anti-lock braking system (220) and the control unit (250) as claimed in claim 9.

11. The method (100) as claimed in claim 1, wherein the control signal (280) is output such that the change to the braking variable (211) takes place alternatively or in addition to an ABS control by the anti-lock braking system (220) or alternately therewith.

12. The method (100) as claimed in claim 5, wherein the vehicle dynamics variable (262) and/or sensor data of the vehicle dynamics control comprises: a yaw rate (263a), a pitch rate (263b), a wheel speed of a wheel (215′) external to the axle, an axle load of a wheel (215′) external to the axle, a normal force acting between a further wheel (215′) of a further axle (205′) and the ground (300), and/or a friction coefficient between the further wheel (215′) of the further axle (205′) and the ground (300).

13. The method (100) as claimed in claim 1, wherein the control variable (270) relating to the axle and/or relating to the wheel (215) of the axle (205) comprises a predicted wheel speed, a predicted slip threshold, a predicted friction coefficient, and/or a predicted normal force between the wheel (215) and the ground (300).

14. The method as claimed in claim 1, wherein the axle is a rear axle.

15. The method as claimed in claim 1, wherein the braking variable is a variable determining a braking torque of the wheel and/or the wheels of the axle which may be applied to the service brake as a result of the control signal.

16. The method as claimed in claim 1, wherein the wheel and/or the axle are controlled by the ABS depending on information, data or variables which are not dependent, or are only indirectly dependent, on the control of the wheel and/or the axle.

17. The method as claimed in claim 2, wherein the ABS has not been activated prior to the trigger signal.

18. The method as claimed in claim 5, wherein the vehicle dynamics variable and/or sensor data relate to information, data or variables of a further wheel of a further axle, wherein the further axle is different from the axle having the wheel to be braked.

19. The method as claimed in claim 6, wherein the environment variable characterizes properties of the ground or roadway.
